(19) United States
(12) Patent Application Publication
(10) Pub. No.: US 2021/0402326 A1
(43) Pub. Date: Dec. 30, 2021

(54) GLASS-FREE NONWOVEN COALESCER

(71) Applicant: Swarna Agarwal, Modesto, CA (US)

(72) Inventor: Swarna Agarwal, Modesto, CA (US)

(73) Assignee: Parker-Hannifin Corporation, Cleveland, OH (US)

(21) Appl. No.: 17/470,558

(22) Filed: Sep. 9, 2021

Related U.S. Application Data
(63) Continuation of application No. PCT/US2020/022047, filed on Mar. 11, 2020.
(60) Provisional application No. 62/817,091, filed on Mar. 12, 2019.
(60) Provisional application No. 62/916,543, filed on Oct. 17, 2019.

(51) Int. Cl. B01D 17/04; F02M 37/34; B01D 39/16

(52) U.S. Cl. CPC B01D 17/045; F02M 37/34; B01D 39/163; B01D 2275/10; B01D 2239/0622; B01D 2239/0668; B01D 2239/0618

(57) ABSTRACT

A filter element and methods of use and forming are provided. The filter element provides water coalescing and separation functions downstream from particulate filtration functions. At least the coalescing stage of the filter element may be glass free. The coalescing stage may have density graded media to accommodate increase water droplet size due to water coalescing.

### CROSS-REFERENCE TO RELATED PATENT APPLICATIONS

This patent application is a continuation of U.S. PCT Application No.: PCT/US2020/022047, filed Mar. 11, 2020, which claims the benefit of U.S. Provisional Patent Application No. 62/916,543, filed Oct. 17, 2019, and U.S. Provisional Patent Application No. 62/817,091, filed Mar. 12, 2019, the entire teachings and disclosure of which are incorporated herein by reference thereto.

### FIELD OF THE INVENTION

The present invention relates to filtering fluid and particularly coalescing filters for filtering dispersed liquid droplets from a flow of fluid, in particular from fuel.

### BACKGROUND OF THE INVENTION

Filters are used to filter impurities from gases and fluids. For example, filters are used to remove particulate impurities as well as water from fuel to improve the operation of downstream systems and prevent damage thereto. Coalescing media with filters is used to cause emulsified dispersed droplets within a fluid, to combine into larger droplets, which can then be removed from the fluid by way of, for example, a stripper or by way of gravity or buoyancy.

Some representative prior art includes DE 11201110295 T5; U.S. Pat. No. 8,517,185 B2 and RU2654979 C1; DE 102014015942 A1; US Publ. No. 2018/0230952 A1; DE 10211120638 A1; and US 2014/0284263 A1.

The suspended phase is called the discontinuous or dispersed phase, while the fluid in which the dispersed phase is suspended is called the continuous phase. As the interfacial tension (IFT) between the continuous phase fluid and the dispersed phase fluid decreases, it becomes more challenging to coalesce the dispersed droplets and separate them from the continuous phase. For example, separating dispersed water droplets out of fuel becomes tougher as the IFT decreases. Prior fuel filters have had difficulty coalescing and separating water from fuel when the IFT is less than or equal to 16 mN/m. As such, these filters have had reduced effectiveness for removing water from fuels having a low IFT with water such as fuels having a biodiesel blend % greater than or equal to 0.1%.

Another problem with prior fuel filters is that when the same filter stage is used to both filter suspended particulate matter as well as water from the fluid, the removed particulate matter can decrease the water coalescing and separation ability over the life of the filter stage. This is because the pores and surface of the fibers of the filter media of the filter stage become occupied with the solid and soft contaminates present in the fluid, in particular fuel. If present, fuel additives can similarly affect the filter stage.

Due to this, the incoming tiny water droplets of emulsified water within the unfiltered fluid do not adhere to the fibers of the filter media and further coalesce. Additionally, the water droplets within the fuel are forced to pass through smaller than desired pore sizes in the filter media. This can cause the water droplets to disperse rather than coalesce or grow in size. The uncoalesced water droplets remain in the fuel stream and then simply pass through the filter. This problem increases over time due to the accumulative buildup of impurities in the filter media such that the water separation characteristics of the filter decrease over time and the filter has increasingly poorer water separation throughout the lifecycle of the filter. In other words, the water separation characteristics deteriorate significantly throughout the lifecycle of the filter.

Another problem with prior filters is that the filter media of conventional coalescing filters will often include a glass layer formed from chopped glass fibers. The layer may be co-pleated with another material such as a melt blown or spun bond layer. Unfortunately, the chopped glass fibers may migrate with the filtered fluid under pressure-pulsation of fluid flow or vehicle vibrations. Glass fibers present in fuel filters typically range from 0.2-4 micron in size which overlaps with injector nozzle clearances and can be abrasive. As such, the presence of glass fibers can damage or otherwise negatively impact the performance of downstream fuel injectors.

The present disclosure relates to improvements over the current state of the art.

### BRIEF SUMMARY OF THE INVENTION

In one aspect of an embodiment, a filter element is provided. The filter element includes an upstream media pack, an optional downstream barrier mesh and a coalescing core located between the flow path of upstream media pack and barrier mesh. The upstream media pack is configured to remove particulates, e.g. soft and solid, from a fluid stream. The coalescing core coalesces dispersed emulsified droplets in the fluid stream. The coalescing core includes an optional upstream scrim layer, a downstream release layer, and at least three coalescing layers upstream of the downstream release layer and downstream from any optional scrim layer. The fibers of each coalescing layer being courser than the fibers of any upstream coalescing layer.

The fibers of the coalescing layer may be melt blown fibers.

In one embodiment, the coalescing layers together have a gradient density structure.

In one embodiment, the coalescing core is glass-free.

In one embodiment, the at least three coalescing layers are each polybutylene terephthalate and the downstream release layer is Polyethylene terephthalate, polyester or viscose rayon.

In one embodiment, the upstream media pack, downstream barrier mesh and coalescing core are arranged in an annular, non-pleated configuration.

However, alternative arrangements can have the coalescing core formed by concentric pleat pack or it can be arranged in a conical/hexagonal/octagonal/oval arrangement. The coalescing core can be formed by wrapping different pre-formed layers annularly or helically to form the core. Further yet, the layers could be formed by directly spraying or laying fibers on a highly porous support structure or each other if the desired gradient density is formed.

Similarly, the upstream media pack could be pleated, wrapped, stacked, etc.

In one embodiment the upstream media pack, downstream barrier mesh and coalescing core are glass-free.

In one embodiment, the downstream barrier mesh is hydrophobic. However, in alternative arrangements, the barrier mesh could be hydrophilic, oleophobic or oleophilic depending on the dispersed and continuous phase liquids. For example, for dispersed oil separation from wastewater, the barrier mesh could be hydrophilic and oleophobic.

In one embodiment, upstream media pack is a pleated media pack and the coalescing core is a cylindrical media pack of wound filter media.

In one embodiment, each of the at least three coalescing layers has a pore size, the pore size of each coalescing layer being greater than the pore size of any coalescing layer upstream thereof, this pore size could be an average pore size and/or a maximum pore size.

In one embodiment, the at least three coalescing layers includes: a) a first coalescing layer having a nominal mean fiber diameter of between about 0.7 and 5.0 micron; an average pore size of less than about 12 micron; a max pore size of less than about 20 micron; an air permeability of between about 12 and 40 CFM at 125 Pa; a thickness of between about 0.8 and 3.0 mm; and a basis weight of between about 100 and 200 g/m²; b) a second coalescing layer downstream from the first coalescing layer having a nominal mean fiber diameter of between about 0.8 and 10.0 micron; an average pore size of less than about 15 micron; a max pore size of less than about 25 micron; an air permeability of between about 15 and 65 CFM at 125 Pa; a thickness of between about 0.4 and 1.0 mm and a basis weight of between about 50 and 100 g/m²; and C) a third coalescing layer downstream from the second coalescing layer having a nominal mean fiber diameter of between about 2 and 15 micron; an average pore size of less than about 25 micron; a max pore size of less than about 50 micron; an air permeability of between about 60 and 100 CFM at 125 Pa; and a thickness of between about 0.3 and 0.8 mm and a basis weight of between about 30 and 70 g/m².

In on embodiment, the average pore size of the first coalescing layer is at least 5 micron, the average pore size of the second coalescing layer is at least 8 micron and the average pore size of the third coalescing layer is at least 15 micron.

In one embodiment, the coalescing core has improved coalescing efficiency for emulsified dispersed water droplets and low fuel-water interfacial tension than the conventional fuel filters. This may be illustrated in FIG. 4 For example, some embodiments may have a water coalescing efficiency of greater than 50% and more preferably greater than or equal to 70%, more preferably greater than or equal to 85% and even more preferably greater than or equal to 99% for fuel-water interfacial tension between 5-60 mN/m and for emulsified dispersed water droplets. Again this may be illustrated in FIG. 4.

In one embodiment, the scrim layer and release layer are formed from polyethylene terephthalate or polyester, wherein the scrim layer has a thickness that is less than the release layer, an air permeability at 125 Pa that is greater than the air permeability of the release layer and a nominal mean fiber diameter that is same or greater than the release layer.

In one embodiment, the upstream media pack is a first filtration stage and the coalescing core is a second filtration stage. These stages are not co-formed with one another (e.g. co-pleated).

In one embodiment, the downstream barrier mesh removes coalesced water droplets from the flow of fuel.

In one embodiment, the release layer is adsorbent to water when in diesel fuel.

In one embodiment, a water drainage is not provided upstream of the upstream media pack.

In one embodiment, a method of removing emulsified water from a flow of fuel is provided. The method includes passing a flow of fuel through a filter element as outlined above. The method includes removing particulate matter with the upstream media pack. The method includes coalescing the emulsified water within the flow of fuel with the at least three coalescing layers. The method includes adhering coalesced water droplets exiting the at least three coalescing layers to the release layer until the water droplets reach a size where hydrodynamic shear forces acting on the water droplets are greater than adhesion forces adhering the water droplets to the release layer. The method includes separating the water droplets released from the release layer from the flow of fuel.

In one method, the step of the separating the water droplets released from the release layer from the flow of fuel is provided by gravitational forces or a barrier mesh downstream from the coalescing core.

This mesh may be hydrophobic, hydrophilic, oleophilic, or oleophobic or combinations thereof depending on the fluids being filter and the dispersed droplets being coalesced.

In an embodiment, a method of forming a filter element as described is provided. The method includes forming the upstream media pack. The method includes forming the coalescing core separately from the upstream media pack. For example, the media pack is not formed with the coalescing core.

In one method, the step of forming the upstream media pack includes forming a tubular pleat pack, which may be cylindrical, oval, polygonal in shape. The step of forming the coalescing core does not include co-pleating the coalescing core with the upstream media pack.

The upstream pleat pack in methods and apparatuses could be copleated with different media or a wire mesh/support structure other than the coalescing core. Further more than one concentric pleat pack could be provided. For example, different pleat packs of different micron rating can be provided upstream of the coalescing core.

Alternatively, the upstream media pack may be wrapped, stacked disks or any other form.

In one method, the step of forming the coalescing core includes wrapping the at least three coalescing layers into a non-pleated multi-layer tube.

However, the coalescing core layers could be pleated, stacked disks, conical/hexagonal/octagonal/oval or other forms. The coalescing core can be formed by wrapping different pre-formed layers of media in annular or helical form or by directly spraying fibers of the desired parameters for the particular layers in gradient density form on a highly porous support structure or support tube like, perforated center tubes or plastic cage. For helical or annular wrapping process, each coalescing core layer can be wrapped individually in the specified gradient density order. Alternatively, all the layers of the coalescing core can be ultrasonically laminated in the specified order to get a single media sheet and then it is wrapped around a highly porous support such as a support tube. During an annular or helical wrapping process, the overlapping edges need to be sealed along the length of the support. The coalescing core support tube must be perforated like a cage.

In an embodiment, a filter element including an upstream media pack and a coalescing core is provided. The upstream media pack is configured to remove particulate in a fluid stream. The coalescing core is downstream of the upstream media pack. The coalescing core includes a downstream release layer, and at least three coalescing layers fibers upstream from the downstream release layer. A nominal fiber diameter of each coalescing layer is greater than a nominal fiber diameter of any upstream coalescing layer. An average pore of each coalescing layer is greater than an average pore size of any upstream coalescing layer. An air permeability of each coalescing layer is greater than an air permeability of any upstream coalescing layer. A basis weight of each coalescing layer is less than a basis weight of any upstream coalescing layer.

In an embodiment, the coalescing core is formed from meltblown fibers. The coalescing layers could be manufactured by way of spun-melting, force-spinning, nano-spider, electroblowing, wetlaid, spunbond, drylaid or other nonwoven manufacturing processes.

In an embodiment, the shape of the coalescing core fibers is circular, but it can be any shape including trilobal, multi-lobal, polygonal, oval, circular serrated, triangular, flat, star shaped, dog boned, square, or any other shape.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified cross-sectional illustration of a filter element showing a particulate filtration stage, a water coalescing stage and a water removal stage in either a cylindrical configuration or a stacked configuration;

FIG. 2 is an enlarged illustration of the water coalescing stage of FIG. 1; and

FIG. 3 is an enlarged illustration of an alternative water coalescing stage.

FIGS. 4-8 are charts illustrating improved performance characteristics of filter elements configured according to embodiments of the disclosure as compared to conventional filters.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

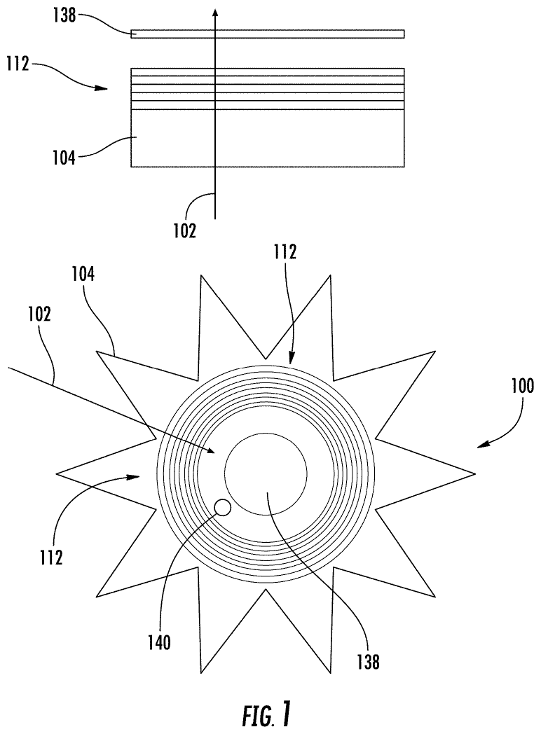

FIG. 1 is a simplified partial cross-sectional illustration of a filter element 100 according to an embodiment. The filter element finds particular use in filtering impurities from fluids including hydrocarbon liquids or a blend of hydrocarbon liquids (for example fuel including diesel fuel, biodiesel ultra-low sulfur diesel (ULSD), hydraulic oils, kerosene, jet fuel) or aerosols. The filter element 100 is a multi-stage filter element that includes an upstream first stage that performs particulate and soft material filtration, an intermediate second stage that coalescing, and a downstream third stage that removes the coalesced fluid. Embodiments find particular use in filtering emulsified water droplets from hydrocarbon fuels.

However, the system can also be used to remove any dispersed oil droplets from water, such as wastewater. In this instance, the system would be turned upside down by 180 degrees for floating coalesced oil removal from the water, e.g. purified wastewater.

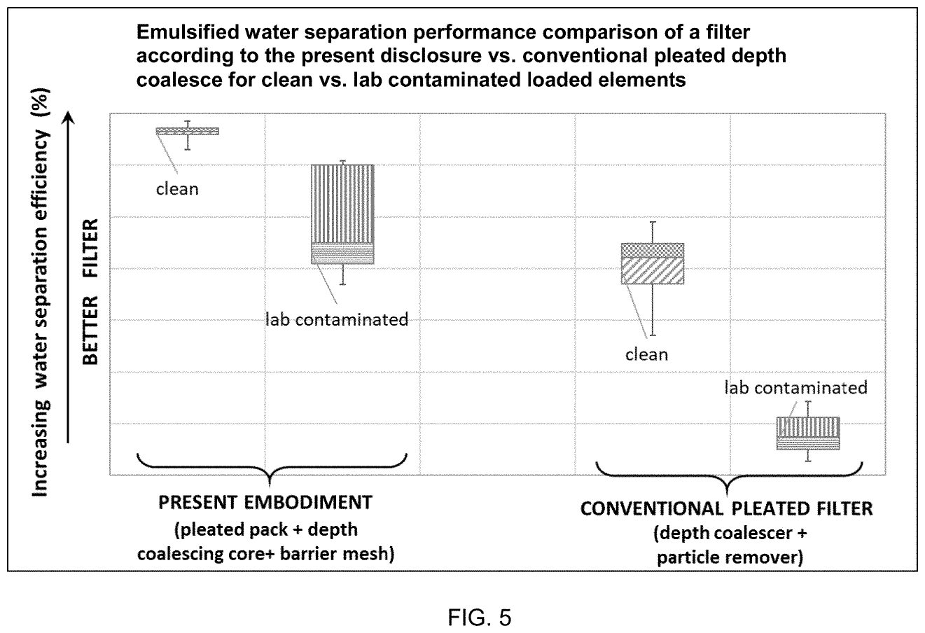

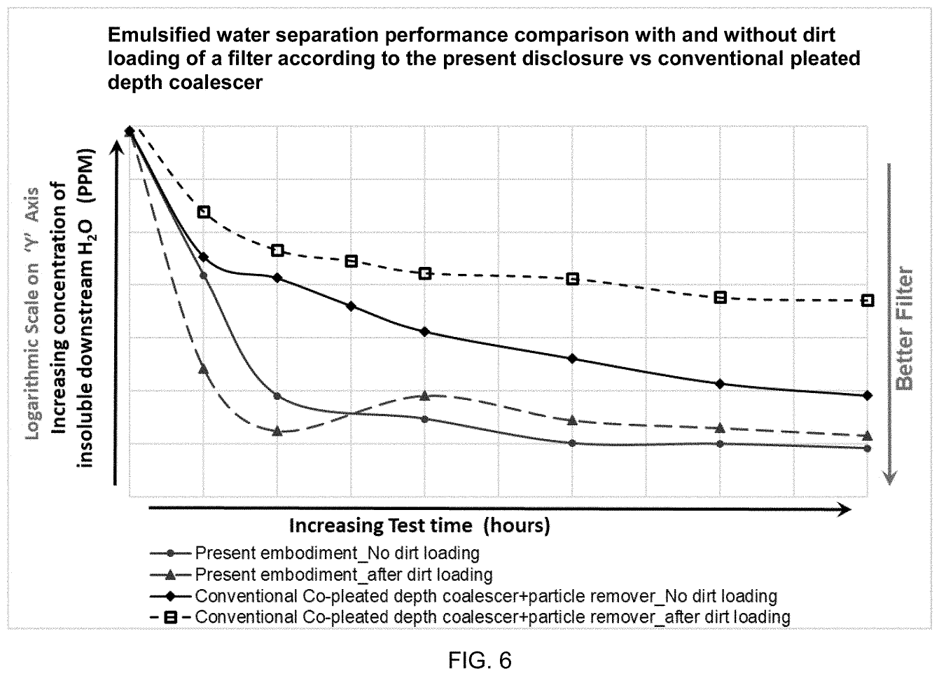

The particle removal function and water separation function are separated into separate stages. This prevents the particle removal function of the filter element from degrading the performance of the water separation function of the filter element over the lifecycle of the filter element. As such, water coalescing and separation capabilities are maintained over to a greater extent the lifecycle of the filter element and improved over conventional pleated depth coalesce filters or barrier style filters. For example, FIGS. 5 and 6 are comparing the emulsified water separation performance at low IFTs of the present embodiment with the comparable conventional pleated depth coalescer before and after lab contamination loading. It is evident from FIGS. 5 and 6 that filters according to the disclosure provide much superior emulsified water separation efficiency before and after lab contamination loading than the comparable conventional pleated depth coalescer. For prior conventional filters, the water coalescing and separation capabilities would typically be determined based on the particulate holding capacity of the filter element.

While FIG. 1 illustrates at least three stages, features of the present disclosure may be incorporated in a two stage filter element. For example, a filter element may incorporate the water coalescing and water stripping functions into a single stage.

The flow of fluid through the various stages of the filter element 100 is illustrated by arrow 102. While the present embodiment provides a radially inward directed flow, features of the present embodiment could be incorporated into a radially outward directed filter element configuration.

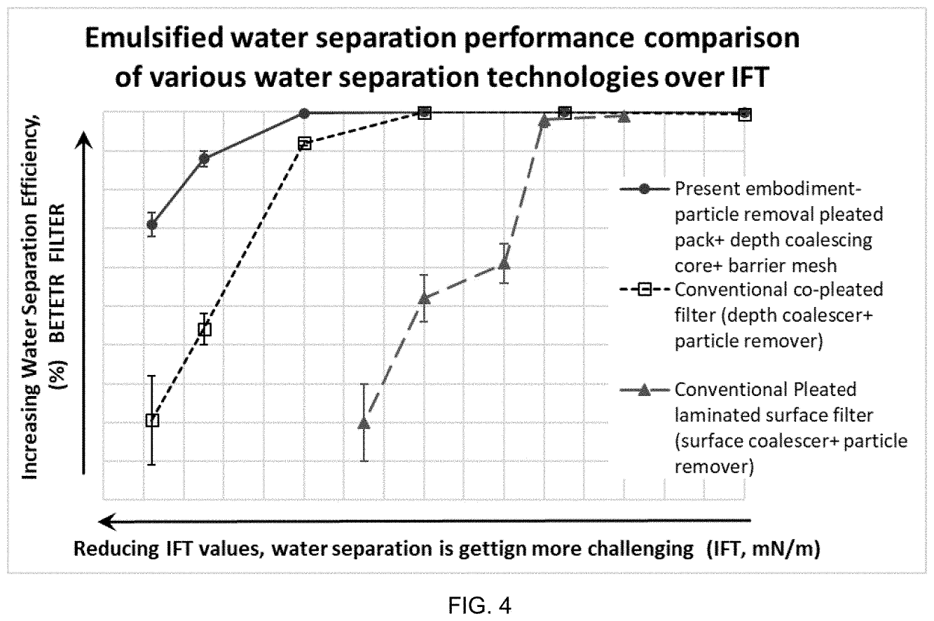

Charts comparing emulsified dispersed water droplets coalescing and separation performance of filters according to the present disclosure to conventional filters are provided in FIGS. 4-8.

FIG. 4 illustrates, at least in part, improved emulsified water separation performance in terms of efficiency as a function of IFT of filters according to the present disclosure.

FIGS. 5 and 6 illustrates that the emulsified water separation efficiency at low IFT is maintained to a greater degree over the life of filters (e.g. when the filter becomes loaded with particulates) according to the present disclosure as compared to comparable conventional filters such as co-pleated depth coalescing filters. FIGS. 5 and 6 also illustrates how the water separation efficiency itself is improved for clean filters as compared to convention filters in their clean state.

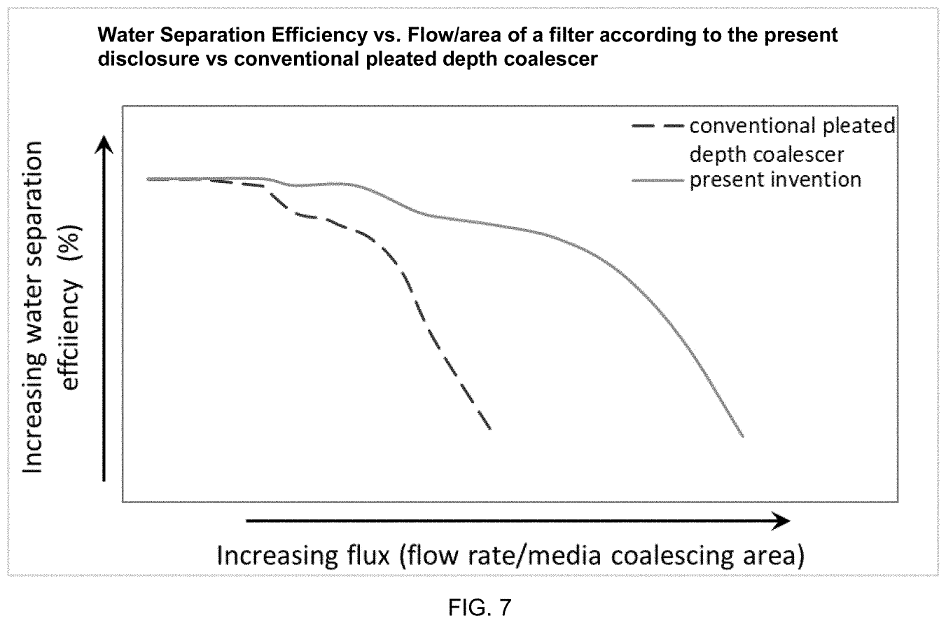

FIG. 7 illustrates how filters according to the present disclosure provide improved water separation efficiency at higher flow rate/area of coalescing media as compared to conventional pleated depth coalescing filters.

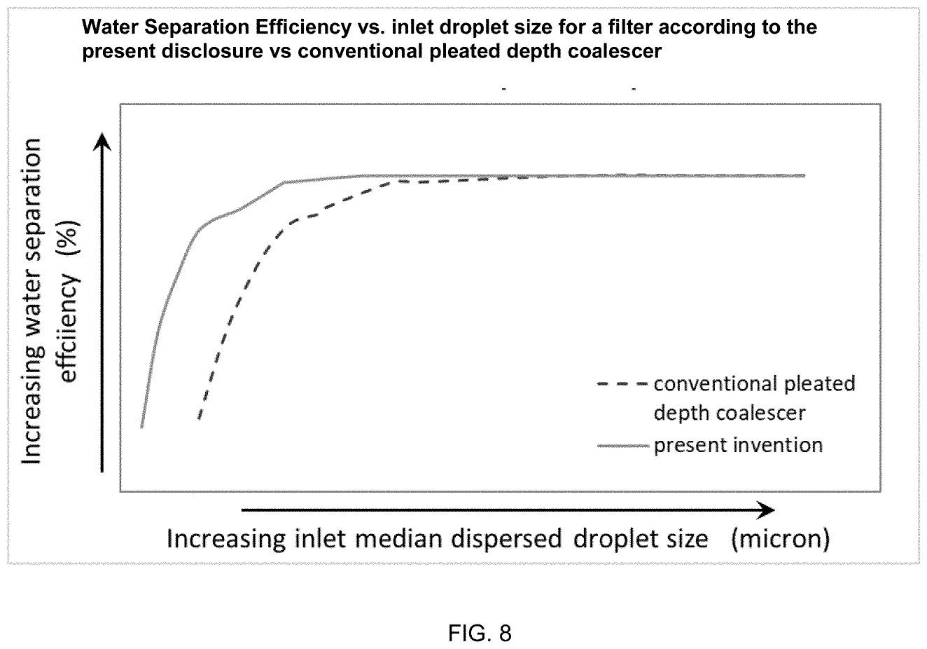

FIG. 8 illustrates how filters according to the present disclosure provide improved water separation efficiency at reduced inlet median dispersed water droplet size compared to comparable conventional pleated depth coalescing filters.

Particular features, characteristics and embodiments will be described below.

In the illustrated embodiment, the first stage is pleated filter media pack 104 configured to separate particulate matter, which includes both solid and soft impurities. While illustrated schematically as a tube of pleated filter media, the filter media pack 104 could take other shapes such as being a cylindrical tube that does not include pleats. For example, the cylindrical tube could be a wrapped filter media.

In the illustrated embodiment, the first stage is pleated filter media pack 104 configured to separate particulate matter, which includes both solid and soft impurities. While illustrated schematically as a cylindrical tube of pleated filter media, the filter media pack 104 could take other shapes such as being a cylindrical or oval tube, rectangular, square, polygonal that does not or may include pleats. For example, the cylindrical tube could be a wrapped filter media or stacked disk media. The filter media of filter media pack 104 is preferably glass-free to entirely eliminate the risk of glass fiber migration. However, due to the inclusion of the second stage, the risk of glass fiber migration is reduced such that the filter media pack 104 could contain up to 100% glass fibers.

Additionally, the filter media pack 104 may be formed from synthetic material or cellulous materials or a combination of synthetic, glass and cellulose with the use of a single manufacturing technology or a combination of different nonwoven manufacturing technologies. The first stage media pack 104 could also be co-pleated with media from a same or different non-woven manufacturing technology. Alternatively, the filter stage media pack 104 could be co-pleated with a wire or plastic mesh and nonwoven made from any nonwoven technology including wetlaid, dry-laid, polymer-laid.

The filter media pack 104 could include a plurality of media packs of different micron rating (pleated or unpleated).

Because the filter media pack 104 is not intended to provide any water coalescing or water separating functions, the filter media of the filter media pack 104 may be made tighter than the coalescing core that filter media otherwise intended to additionally coalesce or separate water from the fluid flow. This allows the efficiency of the filter media pack 104 to be better (e.g. smaller particulate size can be filtered) than prior art filters. In some embodiments, the filter media of filter media pack 104 can have an efficiency rating of between about 1-15 μm and is preferably between about 2-10 μm. However, other ranges and values are contemplated.

To obtain these efficiency ranges, the pore size of the media typically needs to be reduced. However, if the first stage was also used for water coalescing, the reduction in pore size counteracts the desired water coalescing features. This is because the emulsified water droplets would be forced through smaller than desired pores, which would cause any water droplets that have developed to disperse. This is particularly true over the life time of the filter.

Due to the simplified view of FIG. 1, the filter media of filter media pack 104 is illustrated as a single layer. However, filter media pack 104 could be formed by multiple laminated layers of filter media and may be co-pleated with a meltblown, glass, synthetic fibers layer, their composite or a support layer such as a metal or plastic scrim or rigid support.

Downstream from the first stage, e.g. filter media pack 104, is a second stage. The second stage provides water coalescing and water separating features.

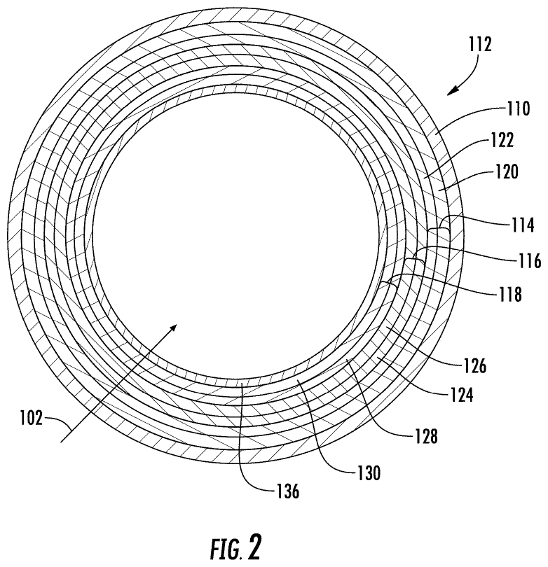

In the illustrated embodiment of FIG. 1 and with additional reference to FIG. 2, the second stage is formed from a plurality of layers, some of which are formed from sublayers. In a preferred embodiment, some or all of the layers of the second stage are formed by wrapping the relevant filter media to form a tubular second stage. In some embodiments, some or all of the layers of the second stage are non-pleated.

The layers of the second stage will be described with reference to the direction of fluid flow through the second stage. The second stage may be referred to as a coalescing core 112. In an embodiment, the coalescing core provides depth coalescing rather than surface coalescing.

The coalescing core can be a pleated concentric pleat pack downstream of upstream media pack 104, or it can be arranged in a stacked disk pattern or conical/hexagonal/octagonal/oval tube form or any other form. The coalescing core can be also formed by wrapping different pre-formed layers in annular or helical form or by directly spraying fibers of the specified parameters in the gradient density form on a highly porous support structure/tube, like perforated metal center tubes or plastic caged center tube.

The coalescing core should be downstream of the upstream media pack 104 and should have sufficient rigidity to not to collapse under the flow and pressure of the desired application.

The first layer is in the form of scrim 110 and is the upstream most layer of the second stage. The scrim layer 110 protects the layers downstream, such as during the element assembling or wrapping process of the downstream layers.

The scrim layer 110 is preferably formed from polyethylene terephthalate or polyester, nylon or any other thermoplastic polymeric fibers/filaments chemically compatible with the dispersed and continuous phase fluid. Preferably, the scrim layer 110 is a spunbond polyester. The scrim layer 110 preferably has a nominal mean fiber diameter of greater than 10 micron and preferably between about 15-40 micron, has an average pore size in excess of about 50 micron, has a max pore size of greater than 100 micron, has an air permeability at 125 Pa of greater than about 500 cubic feet per minute (CFM) and preferably between about 780 and 926 CFM, has a thickness that is greater than or equal to about 0.1 mm and preferably between 0.11 and 0.13 mm, and has a basis weight of between about 10 and 30 g/m² and preferably between 16 and 18 g/m².

The scrim layer is generally non-functional as it relates to the filtering of particulates or water from the fuel flow. As such, while particular parameters such as pore size and max pore size are identified, these parameters may vary.

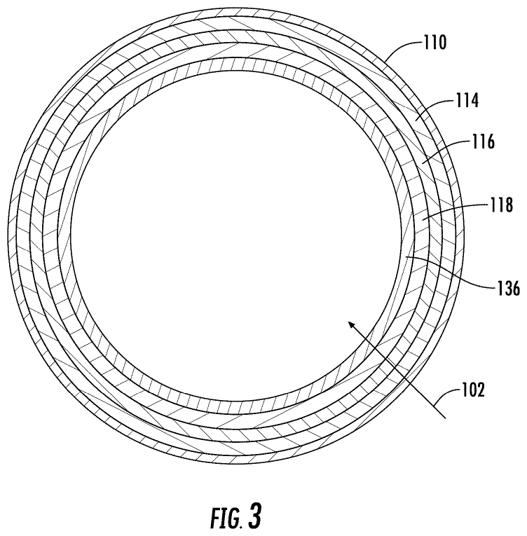

Downstream from the scrim layer 110 is a plurality of coalescing layers 114, 116, 118 arranged in a gradient density form. While three coalescing layers are illustrated, more coalescing layers could be provided. In the illustrated embodiment, each coalescing layer 114, 116, 118 is formed from two sublayers in the illustrated embodiment. This was done to provide the desired material thickness. However, in other embodiments, such as illustrated in FIG. 3, each coalescing layer could be formed from a single layer of material rather than multiple sublayers of the same material.

In a preferred embodiment, the coalescing layers 114, 116, 118 are formed from meltblown fibers, but can be also manufactured by other nonwoven technologies as well, including, but not limited to spun-melting, force-spinning, nano-spider, electro-blowing, wetlaid, spunbond, drylaid or any other nonwoven manufacturing technology, if each layer meets the structural properties.

Preferably, the fibers of the coalescing layers 114, 116, 118 are made of polybutylene terephthalate (PBT), nylon, viscose, polyether sulfones (PES), polyvinylidene difluoride (PVDF), or polyethylene terephthalate (PET), Polyurethane, Polytetrafluoroethylene (PTFE) or any other thermoplastic polymeric fibers/filaments chemically compatible with the dispersed and continuous phase fluids. More preferably, the melt blow fibers are dry laid rather than wet laid to maintain porosity.

The fiber size distribution of each coalescing layer can be polymodal or bi-modal. Bimodal is preferred over polymodal. With bi-modal fiber size distribution a lower basis weight, thickness or no. of coalescing layers can be used. Even with bi-modal fiber size distribution, an increasing bi-modal fiber diameter in a gradient density form from upstream to downstream side is preferred for different layers.

To allow the emulsified water droplets within the fuel to coalesce to form water drops with increasing size, the coalescing layers 114, 116, 118 are configured to prevent pressuring the ever increasing in size water droplets to prevent redispersion.

In a preferred embodiment, the coalescing core 112 is configured to provide improved water coalescing and separation efficiency for emulsified water droplets and low IFT fuels than conventional fuel filters. This is illustrated in the chart in FIG. 4. For example, some filters according to parameters of the present disclosure have a water coalescing and separation efficiency of greater than or equal to 50%, preferably greater than or equal to 70%, preferably greater than or equal to 85% and even more preferably greater than or equal to 99% for emulsified dispersed water droplets and IFT's that are less than or equal to 60 mN/m, and more preferably less than 40 mN/m and even more preferably less than 20 mN/m and are greater than or equal to 5 mN/m when the filter element is in a new/clean state.

Further, due to the configuration of the element, the water separation efficiency is maintained reasonably well over the service life of the filter element 100. For example, FIGS. 5 and 6 are comparing the emulsified water separation performance at low IFTs for filters according to the present disclosure with the comparable conventional pleated depth coalescer before and after lab contamination loading. It is evident from FIGS. 5 and 6 that the present embodiment is providing much superior emulsified water separation efficiency before and after lab contamination loading than the comparable conventional pleated depth coalescer

To accommodate the increasing water droplet size and prevent redispersion of the growing water droplet size, when moving downstream from one coalescing layer to the next coalescing layer, preferably, the nominal mean fiber diameter preferably increases, the average pore size increases, the air permeability (at a same pressure) increases, and the basis weight decreases. In some embodiments, the max pore size increase also increases in the downstream direction.

As noted above, in FIG. 2, each coalescing layer includes multiple sublayers. In FIG. 2, the first coalescing layer 114 has first and second sublayers 120, 122. In this embodiment, the sublayers 120, 122 are identical. Two sublayers are used to provide a desired overall thickness in the radial direction (i.e. direction of fluid flow through first coalescing layer 114).

The first coalescing layer 114 captures the tiniest water droplets from the fuel flow.

In one embodiment, the entire first coalescing layer 114 (e.g. combination of sublayers 120, 122) has a nominal mean fiber diameter of between about 0.5 and 9 micron and more preferably between about 0.7 and 5 micron, has an average pore size of less than 12 micron, more preferably between about 5 and 12 micron and even more preferably is between about 10 and 12 micron, has a max pore size of less than 25 micron and more preferably of less than 20 micron, has an air permeability at 125 Pa of between about 12 and 40 cubic feet per minute (CFM) and preferably between about 25 and 40 CFM, has a thickness that is between about 0.8 and 3.0 mm, has a basis weight of between about 100 and 200 g/m², and may have a porosity of between about 10 and 23 percent.

When multiple sublayers 120, 122 are provided, in some embodiments, the thickness of each sublayer 120, 122 may be between about 0.38 and 0.64 mm, the basis weight may be between about 85 and 115 g/m², and the porosity may be between about 10 and 23 percent.

The second coalescing layer 116 is downstream from the first coalescing layer 114. The second coalescing layer 116 further coalesces the water droplets. However, this layer is configured to handle water droplets that are on average larger than the water droplets handled by the first coalescing layer 114.

As such, preferably, the nominal mean fiber diameter preferably increases, the average pore size increases, the max pore size increase, the air permeability (at a same pressure) increases, and the basis weight decreases as compared to the first coalescing layer 114.

In FIG. 2, the second coalescing layer 116 has sublayers 124, 126, which may be formed from identical media or slightly different media.

In one embodiment, the entire second coalescing layer 116 (e.g. combination of sublayers 124, 126) has a nominal mean fiber diameter of between about 0.8 and 10 micron and more preferably between about 0.8 and 4.1 micron, has an average pore size of less than 15 micron, more preferably between about 8 and 15 micron and even more preferably is between about 11 and 15 micron, has a max pore size of less than 30 micron and even more preferably of less than 25 micron, has an air permeability at 125 Pa of between about 15 and 65 cubic feet per minute (CFM) and preferably between about 35 and 65 CFM, has a thickness that is between about 0.3 and 1 mm, has a basis weight of between about 50 and 100 g/m², and may have a porosity of between about 10 and 24 percent.

When multiple sublayers 124, 126 are provided, in some embodiments, the thickness of each sublayer 124, 126 may be between about 0.15 and 0.26 mm, the basis weight may be between about 33 and 47 g/m², and the porosity may be between about 10 and 24 percent.

The third coalescing layer 118 is downstream from the second coalescing layer 116. The third coalescing layer 118 further coalesces the water droplets. Again, this layer is configured to handle water droplets that are on average larger than the water droplets handled by the first and second coalescing layers 114, 116, this is due to the progressive growth in water droplet size due to the coalescing process.

As such, preferably, the nominal mean fiber diameter preferably increases, the average pore size increases, the max pore size increase, the air permeability (at a same pressure) increases, and the basis weight decreases as compared to the second coalescing layer 116.

In FIG. 2, the third coalescing layer 118 has sublayers 128, 130, which may be formed from identical media or slightly different media.

In one embodiment, the entire third coalescing layer 118 (e.g. combination of sublayers 128, 130) has a nominal mean fiber diameter of between about 1.5 and 15 micron and more preferably between about 2 and 11.8 micron, has an average pore size of less than 25 micron, more preferably between about 15 and 25 micron and even more preferably is between about 20 and 24 micron, has a max pore size of less than 55 micron and more preferably of less than 50 micron, has an air permeability at 125 Pa of between about 60 and 190 cubic feet per minute (CFM) and preferably between about 60 and 150 CFM and more preferably between about 60 and 100 CFM, has a thickness that is between about 0.3 and 0.8 mm, has a basis weight of between about 30 and 80 g/m², and may have a porosity of between about 8 and 14 percent.

When multiple sublayers 128, 130 are provided, in some embodiments, the thickness of each sublayer 128, 130 may be between about 0.16 and 0.20 mm, the basis weight of each layer may be between about 22 and 30 g/m², and the porosity may be between about 8 and 14 percent.

Downstream from the coalescing layers 114, 116, 118 and particularly coalescing layer 118, the coalescing core 112 includes a release layer 136. The release layer is the downstream most layer of the coalescing core 112 and is downstream from all of the coalescing layers. The release layer 136 is highly porous and water adsorbent in diesel fuel. The coalesced water droplets exiting the coalescing layers 114, 116, 118 are adsorbed on fibers of the release layer 136. The water droplets remain held by the release layer 136 and continue to coalesce. When the hydrodynamic shear forces on the water droplets overcomes the adhesion forces, the large coalesced water droplets release from the release layer 136.

In one embodiment, the release layer 136 has a nominal mean fiber diameter of that is greater than or equal to about 15 micron, more preferably between about 15 and 30 micron and more preferably between about 15 and 19 micron, has an average pore size of greater than or equal to 40 micron, more preferably between about 40 and 50 micron, has an air permeability at 125 Pa of at least 150 CFM, more preferably between about 150 and 300 cubic feet per minute (CFM) and even more preferably between about 200 and 260 CFM, has a thickness that is greater than 0.4 mm, and preferably between about 0.46 and 0.66 mm, has a basis weight of between about 70 and 170 g/m² and more preferably between about 90 and 120 g/m², and may have a porosity of between about 10 and 19 percent.

The water droplets are then separated from the fuel flow. The mode of separation depends on the configuration of the filter element, e.g. two stage or three stage. In a two stage element, the water droplets may be separated by way of gravity. In a three stage element, the water droplets may be separated by way of gravity in addition to a hydrophobic barrier mesh downstream from release layer 136.

FIG. 1 illustrates a three stage element and includes a barrier mesh 138. In one embodiment, the barrier mesh is a woven material. The hydrophobic properties of the barrier mesh generally repel water while allowing the fuel to continue to travel therethrough promoting separation of the water from the fuel flow. However, depending on the dispersed and continuous phase fluids at issue, the barrier mesh 138 could be hydrophobic, hydrophilic, oleophobic or oleophilic.

The barrier mesh 138 may be formed from PET or any other polymer compatible with the dispersed and continuous phase fluids and may have a mesh size of greater than 10 μm. A mesh size of between about 10 and 120 micron is preferred. In some embodiments, the mesh 138 may be formed from a woven polyester that is hydrophobically treated. Alternatively, a material with a hydrophobic surface can be used. For example, a polyamide (PA) with a hydrophobic surface could be used as the barrier mesh 138.

In a preferred embodiment, the filter element 100 includes a drain 140 that can be used to remove the separated water downstream of the coalescing core 112. It is noted that because the filter media pack 104 is not intended to perform water separation functions, a drain is not required to be provided upstream of the filter media pack 104 (e.g. if it were a surface coalescer) or downstream of the filter media pack 104 and upstream of the coalescing core 112 (e.g. if it was a depth coalescer).

However, in some embodiments, to increase emulsified water separation at very high flow rates, the upstream filter media pack 104 may have water separation characteristics and be used in conjunction with the coalescing core. For example, the filter media pack 104 could have depth or surface coalescing characteristics.

In situations where the filter media pack 104 provides some surface coalescing, without a drain, to the extent that water removal occurs, the media pack 104 would become saturated and water would pass directly through the media pack 104. In filters according to the present disclosure, a drain is only provided downstream to the coalescing core. In order to increase the water separation efficiency, a drain can be provided upstream to an upstream surface coalescing media pack 104 or downstream to a depth coalescing media pack 104 and upstream to the coalescing core 112.

In an embodiment, the coalescing core is glass-free and 100% synthetic in which all the engineered nonwoven layers are arranged in a gradient density form.

The configuration as outlined above efficiently separates emulsified dispersed immiscible liquid droplets suspended in a fluid, which can be hydrocarbon fluid or blend of hydrocarbon fluids (for example diesel fuel, kerosene, jet fuel, biodiesel, home heating oils, hydraulic oil), and aerosols, or others) for low IFTs that are less than or equal to 60 mN/m, preferably less than or equal to 25 mN/m and typically greater than equal to 5 mN/m and more preferably greater than or equal to 7 mN/m.

By separating the water separation and particulate filtering functions and protecting the coalescing core 112 and particularly the coalescing layers 114, 116, 118 from the particulate impurities in the fuel flow with the filter media pack 104, the coalescing layers 114, 116, 118 sees the cleaned fuel flow and are not significantly fouled with the particulate impurities. As a result, the coalescing core 112 maintains reasonable water separation performance throughout the life of the filter element 100, see e.g. FIGS. 5 and 6.

While fluid flow may be radially inward or radially outward, the layered order described above relative to the flow fluid shall remain the same.

It is noted that the configuration of the coalescing core 112 facilitates water coalescing while reducing the risk of redispersion of the water droplets as they increase in size when flowing downstream through the different layers 114, 116, 118 of the coalescing core.

It is noted that per the Young Laplace equation, the larger droplets have lower internal pressure and are more prone to deform compared to smaller droplets. As such, if the pressure drop/area within a coalescing media thickness, which is also equal to travel distance of coalescing water droplets, is not reducing from upstream to downstream, the coalescing droplets will face the same pressure drop and pore size spacing as small inlet droplets. Due to this, the coalescing drops will finally take shape of the pores and will redisperse upon pressure release.

As a result, embodiments of the present disclosure are configured such that the pressure drop is reducing, and pore size is increasing, the coalescing water droplets, which are now larger than when entering the element, are not facing increasing pressure as they are growing and flowing downstream. At the same time, the increasing pore size will provide the growing water droplets sufficient room so that they do no deform and will release from the coalescing core as enlarged water droplets without redispersion.

Further, due to the configuration of embodiments of this disclosure, unlike other prior art water separation filters, nanofibers, and particularly nanofibers being less than 500 nm, are not required to provide for the desired water separation characteristics identified above. This allows the present filter element 100 to avoid the use of nanofibers which can be delicate to handle, have slow production rates, and may be more expensive.

Additionally, in some embodiments, unlike prior art elements, the coalescing core 112 is free of a downstream support layer. However, in other embodiments, such a rigid support layer could be provided. The rigid support layer is preferably highly porous. For example, such a support layer would not, generally, affect the pressure drop across the filter element. However, some minimal increase in pressure drop across the filter element could be provided (e.g. preferably less than 5%). Further, while a support layer may not be provided, a perforated center tube cage may be provided around which the coalescing layers 114, 116, 118 may be wound.

Additionally, in embodiments with an inside-out flow, an outer support can be provided that surrounds the coalescing layers of the coalescing core to provide stability and prevent bulging. For instance, in one embodiment, a cage may be provided around the coalescing core. This would be particularly applicable in high-flow applications. In alternative embodiments, the outer support may be a wire mesh. Again, the outer support preferably does not appreciably affect pressure drop across the filter element.

In some embodiments, the packing density of the coalescing core 112 is greater than or equal to 10%, but could be greater than or equal to 5%. The minimal packing density allows for removal of emulsified water droplets as which are typically very hard to separate from fuel.

The coalescing core 112 can be used for both vacuum and pressure side applications without fuel starvation.

Because the filter media pack 104 is designed to do the particle filtration, it is preferred that the filter media pack 104 has a higher particle removal efficiency than the coalescing core 112.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter element, comprising:
i. an upstream media pack configured to remove particulate in a fluid stream; and
ii. a coalescing core downstream from the upstream media pack for removing water in the fluid stream, the coalescing core comprising:
a) a downstream release layer, and
b) at least three coalescing layers upstream of the downstream release layer, the fibers of each coalescing layer being coarser than the fibers of any upstream coalescing layer.

2. A filter element as in claim 1, wherein the coalescing layers together have a gradient density.

3. A filter element as in claim 1, wherein the coalescing core is glass-free.

4. The filter element as in claim 1, wherein the at least three coalescing layers are each polybutylene terephthalate and the downstream release layer is Polyethylene terephthalate, polyester or viscose rayon.

5. The filter element of claim 1, further comprising a downstream barrier mesh, the coalescing core being positioned between the upstream media pack and the downstream barrier mesh.

6. The filter element of claim 5, wherein the upstream media pack, downstream barrier mesh and coalescing core are glass-free.

7. The filter element of claim 5, wherein the downstream barrier mesh is hydrophobic.

8. The filter element of claim 1, wherein upstream media pack is a pleated media pack and the coalescing core is a cylindrical media pack.

9. The filter element of claim 1, wherein each of the at least three coalescing layers has an average and maximum pore size, the average and maximum pore size of each coalescing layer being greater than the average and maximum pore size of any coalescing layer upstream thereof.

10. The filter element of claim 1, wherein the at least three coalescing layers includes:
a) a first coalescing layer having a nominal mean fiber diameter of between about 0.5 and 5.0 micron; an average pore size of less than about 12 micron; a max pore size of less than about 20 micron; an air permeability of between about 12 and 40 CFM at 125 Pa; a thickness of between about 0.8 and 3.0 mm; and a basis weight of between about 100 and 200 g/m²;
b) a second coalescing layer downstream from the first coalescing layer having a nominal mean fiber diameter of between about 0.8 and 10.0 micron; an average pore size of less than about 15 micron; a max pore size of less than about 25 micron; an air permeability of between about 15 and 65 CFM at 125 Pa; a thickness of between about 0.4 and 1.0 mm and a basis weight of between about 50 and 100 g/m²;
C) a third coalescing layer downstream from the second coalescing layer having a nominal mean fiber diameter of between about 2 and 15 micron; an average pore size of less than about 25 micron; a max pore size of less than about 50 micron; an air permeability of between about 60 and 100 CFM at 125 Pa; and a thickness of between about 0.3 and 0.8 mm and a basis weight of between about 30 and 70 g/m².

11. The filter element of claim 10, wherein the average pore size of the first coalescing layer is at least 5 micron, the average pore size of the second coalescing layer is at least 8 micron and the average pore size of the third coalescing layer is at least 15 micron.

12. The filter element of claim 1, wherein the coalescing core has an emulsified water separation efficiency of greater than or equal to 70% at IFT's that are less than or equal to 60 mN/m.

13. The filter element of claim 1, wherein the coalescing core includes an upstream scrim layer that is upstream of the at least three coalescing layers.

14. The filter element of claim 1, wherein the upstream media pack is a first filtration stage and the coalescing core is a second filtration stage that are not co-formed with one another.

15. The filter element of claim 5, wherein the downstream barrier mesh removes coalesced water droplets from the flow of fuel.

16. The filter element of claim 1, wherein the release layer is adsorbent to water when in diesel fuel.

17. The filter element of claim 1, wherein a water drainage is not provided upstream of the upstream media pack.

18. The filter element of claim 5, wherein the upstream media pack, downstream barrier mesh and coalescing core are arranged in an annular, non-pleated configuration.

19. The filter element of claim 13, wherein the scrim layer and release layer are formed from polyethylene terephthalate or polyester, wherein the scrim layer has a thickness that is less than the release layer, an air permeability at 125 Pa that is greater than the air permeability of the release layer and a nominal mean fiber diameter that is equal to or greater than the release layer.

20. The filter element of claim 1, wherein the coalescing layers are formed from melt blown fibers.

21. A filter element, comprising:
i. an upstream media pack configured to remove particulate in a fluid stream;
ii. a coalescing core is downstream of the upstream media pack, the coalescing core includes:
a) a downstream release layer, and
b) at least three coalescing layers upstream from the downstream release layer, a nominal fiber diameter of each coalescing layer being greater than a nominal fiber diameter of any upstream coalescing layer, and an average pore of each coalescing layer being greater than an average pore size of any upstream coalescing layer.

22. The filter element of claim 21, wherein the fibers of the coalescing layers are meltblown.

23. The filter element of claim 21, wherein an air permeability of each coalescing layer is greater than an air permeability of any upstream coalescing layer, and a basis weight of each coalescing layer is less than a basis weight of any upstream coalescing layer.

24. A method of removing emulsified water from a flow of fuel comprising:
passing a flow of fuel through a filter element according to any preceding claim;
removing particulate matter with the upstream media pack;
coalescing the emulsified water within the flow of fuel with the at least three coalescing layers;
adhering coalesced water droplets exiting the at least three coalescing layers to the release layer until the water droplets reach a size where hydrodynamic shear forces acting on the water droplets are greater than adhesion forces adhering the water droplets to the release layer; and
separating the water droplets released from the release layer from the flow of fuel.

25. The method of claim 24, wherein the step of the separating the water droplets released from the release layer from the flow of fuel is provided by gravitational forces or a barrier mesh downstream from the coalescing core.

26. A method of forming the filter element of claim 1, comprising:
forming the upstream media pack; and
forming the coalescing core separately from the upstream media pack.

27. The method of claim 26, wherein the step of forming the upstream media pack includes forming a tubular pleat pack and the step of forming the coalescing core does not include co-pleating the coalescing core with the upstream media pack.

28. The method of claim 27, wherein the step of forming the coalescing core includes wrapping the at least three coalescing layers into a non-pleated multi-layer tube.
